(19) United States
(12) Patent Application Publication
(10) Pub. No.: US 2014/0012433 A1
(43) Pub. Date: Jan. 9, 2014

(54) SELF-POWERED RELEASABLE AEROSTAT AND METHOD AND SYSTEM FOR RELEASING AND CONTROLLING THE AEROSTAT

(71) Applicant: World Surveillance Group, Inc., (US)

(72) Inventors: George L. Vojtech, Easton, MD (US); Daniyel Erdberg, North Miami, FL (US)

(73) Assignee: World Surveillance Group, Inc., Kennedy Space Center, FL (US)

(21) Appl. No.: 13/889,611

(22) Filed: May 8, 2013

Related U.S. Application Data
(60) Provisional application No. 61/644,183, filed on May 8, 2012.

(51) Int. Cl. B64B 1/06

(52) U.S. Cl. CPC B64B 1/06
USPC 701/2; 244/96

(57) ABSTRACT

A computer-implemented method for releasing and controlling an airship is provided. The method includes receiving instruction signals to release the airship for an autonomous flight, wherein the airship includes a plurality of body segments and a plurality of coupling elements for coupling adjacent body segments along a length of the airship. The method further includes determining environmental conditions affecting the airship, evaluating an internal pressure level of each of the plurality of body segments and a stiffness level of each of the couplings elements, and determining whether the evaluated internal pressure levels and stiffness levels are substantially suitable to the determined environmental conditions. The method further includes, determining whether the propulsion unit is in an operational state, and then based on the determination that the propulsion unit is in an operational state, triggering a disconnection of the tether unit and an activation of the auto pilot unit.

### CROSS-REFERENCE TO RELATED APPLICATIONS

The present application claims priority under 35 U.S.C. §119(e) to U.S. Provisional Patent Application Ser. No. 61/644,183, filed May 8, 2012, which is incorporated herein by reference in its entirety.

### BACKGROUND

A typical airship such as a blimp has a rigid outer envelope filled with a lifting gas such as helium. An airbag or ballonet disposed inside the envelope is used to provide vertical control of the airship and to provide ballast when the airship is aloft. In particular, air is evacuated from the ballonet to outside the airship to cause the airship to ascend and air is pumped into the ballonet to cause the airship to descend. Such an airship may include more than one ballonet to provide ballast and to control the nose-to-tail orientation of the airship.

Due to their rigid outer structures, typical airships may not be maneuverable in weather conditions involving high winds and/or turbulent air. Moreover, high-speed crosswinds may damage the rigid airship. As such, these airships are generally operated on calm days or when high-speed winds are not expected.

Aerostats also have an outer envelope filled with a lifting gas. However, unlike blimps, aerostats are secured to an object/body on the ground by a tether. One end of the tether is attached to the aerostat and another end of the tether is attached to the object that is securely stationed on the ground. The tether holds the aerostat in place over a particular area. As known to one of ordinary skill in the art, an aerostat is not equipped with a propulsion device and a flight controller and, therefore cannot self-navigate to a destination when disconnected from the tether.

### SUMMARY

Disclosed herein are a self-powered releasable aerostat, method and system for releasing and controlling the aerostat.

According to one aspect, a computer-implemented method for releasing and controlling an airship is provided. The method includes receiving instruction signals to release the airship for an autonomous flight, wherein the airship includes a plurality of body segments and a plurality of coupling elements for coupling adjacent body segments along a length of the airship, wherein the airship is detachably coupled to a ground unit through a tether unit, and wherein the airship includes a propulsion unit, an auto pilot unit, and a controlling unit for controlling the propulsion unit, the tether unit, and the auto pilot unit. The method further includes determining environmental conditions affecting the airship, evaluating an internal pressure level of each of the plurality of body segments and a stiffness level of each of the couplings elements, and determining whether the evaluated internal pressure levels and stiffness levels are substantially suitable to the determined environmental conditions. Based on a determination that the evaluated internal pressure levels and stiffness levels are substantially suitable to the determined environmental conditions, the method further includes, determining whether the propulsion unit is in an operational state, and then based on the determination that the propulsion unit is in an operational state, triggering a disconnection of the tether unit and an activation of the auto pilot unit.

According to another aspect, an airship includes a plurality of body segments Tillable with lighter than air gases, a plurality of coupling elements, each of which is positioned to couple adjacent body segments along a length of the airship, a releasable tether unit for securing the airship to a ground unit while the airship is aloft, a propulsion unit for facilitating an autonomous flight of the airship, a controlling unit for triggering a release of the tether unit, for actuating the propulsion unit, and for controlling internal pressure levels of the body segments and stiffness levels of the coupling elements.

According to another aspect, a non-transitory computer-readable medium comprising instructions executing the method for releasing and controlling an airship.

These as well as other aspects, advantages, and alternatives will become apparent to those of ordinary skill in the art by reading the following detailed description, with reference where appropriate to the accompanying drawings. Further, it should be understood that the disclosure provided in this summary section and elsewhere in this document is intended to discuss the embodiments by way of example only and not by way of limitation.

### BRIEF DESCRIPTION OF THE DRAWINGS

In the accompanying figures, like reference numerals refer to identical or functionally similar elements throughout the separate views.

FIG. 1 illustrates an elevated longitudinal side view of an exemplary embodiment of an aerostat, having multiple segments, connected to vehicle via a tether;

FIG. 2 illustrates an elevated longitudinal side view of the aerostat of FIG. 1 with a non-aligned arrangement of the multiple aerostat segments;

FIG. 3 is a cross-sectional view, along a line A-A, of an exemplary embodiment of the tether of the aerostat of FIG. 1;

FIG. 4A is a schematic diagram of an exemplary embodiment of a communication system of the aerostat of FIG. 1;

FIG. 4B is a block diagram of an exemplary embodiment of a control system of the aerostat of FIG. 1;

FIG. 5A illustrates an elevated longitudinal side view of an exemplary embodiment of an aerostat having multiple tethers;

FIG. 5B illustrates an elevated longitudinal side view of another exemplary embodiment of an aerostat having multiple tethers connected to a single tether that is connected to a vehicle or an immobile station;

FIG. 6 illustrates an elevated longitudinal side view of another exemplary embodiment of a single-segment aerostat having a tail;

FIG. 7 is a flow chart illustrating a method for releasing and controlling an a flight of the aerostat of FIG. 1;

FIG. 8 is a block diagram illustrating components of the aerostat controller; and

FIG. 9 is a schematic drawing illustrating a computing network system according to an exemplary embodiment.

Elements in the figures are illustrated for simplicity and clarity and have not necessarily been drawn to scale. For example, the dimensions of some of the elements in the figures may be exaggerated relative to other elements. Further, the apparatus, method and system components have been represented, where appropriate, by conventional symbols in the drawings.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### Overview

As known to one of ordinary skill in the art, an airship, such as an aerostat or a blimp, has an envelope of flexible sheet material that is filled with a lighter than air (LTA) gas, such as helium. The envelope has an aerodynamic configuration, such as a teardrop shape, or a round configuration. However, the overall shape of the airship is set and may not be modified expect very slightly during the filling or removal of the LTA gas. Moreover, as stated above, due to the rigid outer structure, the airship may not be maneuverable in weather conditions involving high winds and/or turbulent air.

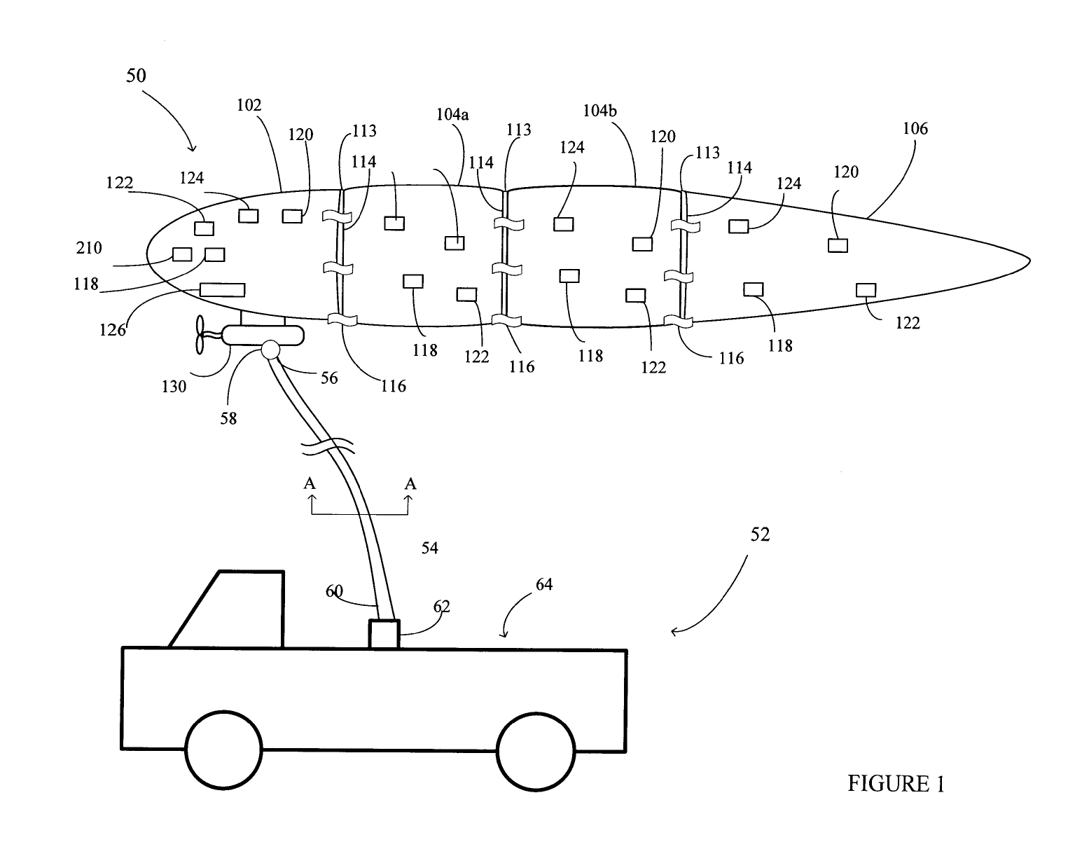

Accordingly, in one exemplary embodiment, an aerostat is configured as a segmented airship. Now referring to FIG. 1, an aerostat 50 includes a head segment 102, one or more body segments 104, and a tail segment 106. At a coupling 113 between any two adjacent segments is a segment closer strap 114 operated by a segment closer module 116 associated therewith. In addition, each segment 102, 104, and 106 includes a sensor module 118, a segment fill-fan-and-valve assembly 120, and a pressure sensor 122. Sensor module 118 includes one or more instrument sensors such as a magnetic compass, an inertial navigation sensor, and a three-axis position sensor. A segment controller 124 is also disposed in each segment 102, 104, and 106, and is configured to receive measurement signals from sensor module 118 and pressure sensor 122 disposed in such segment 102, 104, or 106, and to serialize and transmit such measurement signals to an aerostat controller 126. Further, segment controller 124 is configured to receive from aerostat controller 126 signals for adjusting a stiffness of couplings 113 between adjacent segments 102, 104, and 106, and to increase or decrease the pressure inside segments 102, 104, and 106. In response to the received signals, segment controller 124 is configured to operate corresponding segment closer strap 114 at an associated coupling 113 to increase or decrease the stiffness thereof. Similarly, segment controller 124 is configured to operate fill-fan-and-valve assembly 120 associated with segment 102,104, or 106 to increase or decrease the pressure within such segment 102, 104, or 106. The stiffness of coupling 113 and the pressure inside segments 102, 104, and 106 can be adjusted appropriately to allow aerostat 50 to assume a substantially/suitably rigid structure having a profile shown in FIG. 1. Such profile and rigid structure may enable aerostat 50 to hover over a relatively fixed area in low wind conditions. In one embodiment, aerostat 50 includes a motor driven propulsion module 130 that may be controlled by aerostat controller 126 to propel aerostat 50.

As shown in FIG. 1, aerostat 50 is connected to a ground unit 52, which can be a vehicle or fixed station, through a tether 54. One end 56 of tether 54, which can be a quick connect fitting end, is configured to be releasably coupled to an attachment point 58 located on aerostat 50. Another end 60 of tether 54 is releasably coupled to an attachment point 62 of ground unit 52. Moreover, such releasable ends 56 and 60 can mate with suitable receptacles (not shown) at attachment points 58 and 62 of aerostat 50 and ground unit 52, respectively.

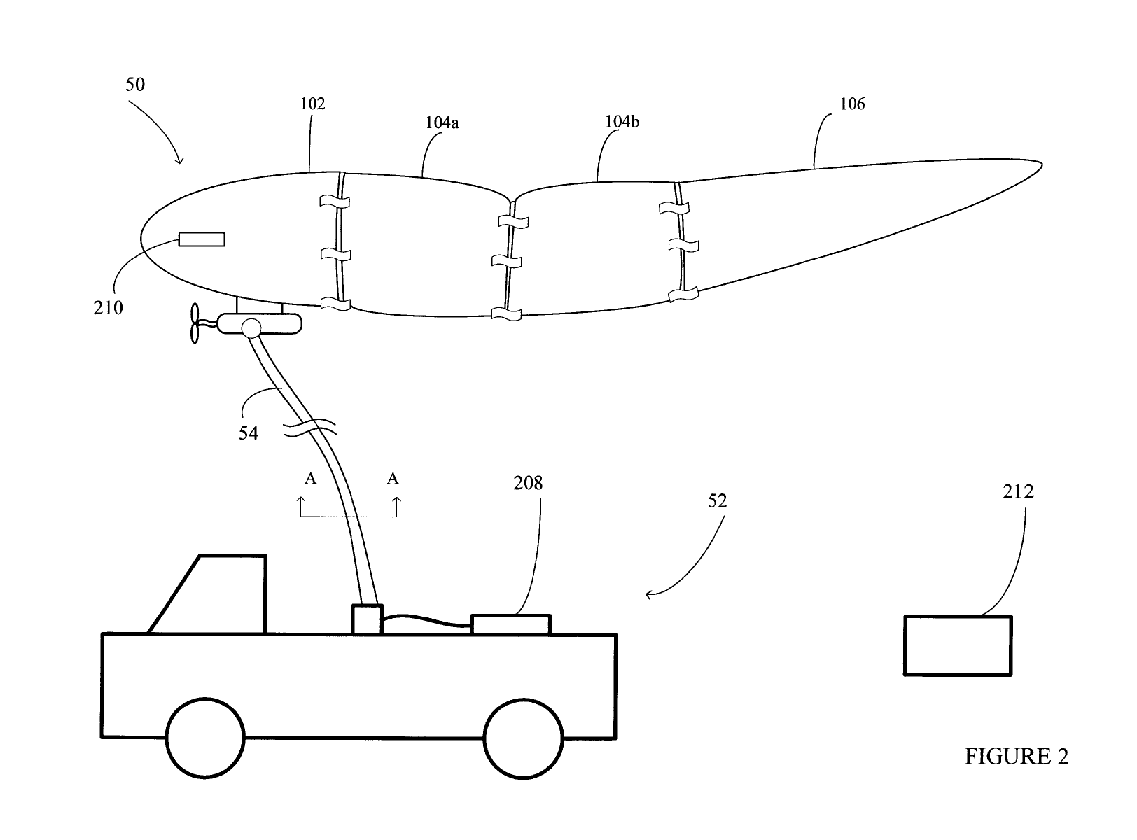

Now referring to FIG. 2, a width of each closer strap 114 and the internal pressure of each segment 102, 104, or 106 may be adjusted to allow aerostat 50 to become flexible or stiff. In case closer straps 114 are configured to have a cylindrical shape, then their respective diameters may reach their widest values during the stiffening process. By constricting one of segment closer straps 114 at the corresponding coupling 113, thereby reducing the stiffness at such coupling 113, may allow a portion of aerostat 50 that includes such coupling 113 to become flexible. That is, segments 102, 104, and 106 of aerostat 50 can be moved with respect with one another. Moreover, it should be apparent that the diameters/widths of closer straps 114 between adjacent segments 102 and 104a, 104a and 104b, and 104b and 106 may not be identical and therefore stiffness at couplings 113 between such adjacent segments may vary. In high wind and/or turbulent air environments, such flexibility can allow each segment 102, 104, or 106 of aerostat 50 to drift into a position that reduces a gradient of the wind with respect to such segment (that is, such segment presents a minimized cross-section to the wind). With this segment-closer strap arrangement, aerostat 50 can remain airborne even in high wind and/or turbulent air conditions without being at risk of being damaged by crosswinds. Moreover,

As known to one of ordinary skills in the art, one technique for providing power to electrical devices/systems aboard aerostat 50 is to carry an electrical generator on board. This arrangement is configured to provide all the necessary power needs of aerostat 50 in a somewhat efficient manner. Unfortunately, electrical generation equipment is quite heavy and decreases a potential load equipment that may be carried by aerostat 50. Another drawback of employing an on-board power generator is the reduced “availability” of aerostat 50. In other words, the generator typically only has enough fuel to electric components of aerostat 50 for a few days. At the end of which, aerostat 50 must be retrieved, serviced, and then re-deployed. In order to increase the availability of aerostat 50, a ground-based power supply system located in ground unit 52 is configured to provide power to aerostat 50 through tether 54. As such, any problem with the ground-based power supply system can be easily dealt with on the ground instead of having to retrieve aerostat 50 anytime the onboard electrical generator has a malfunction. Moreover, ground-based power supply system is used to supply power to aerostat 50 so that power sources, such as power storage units, on board aerostat 50 may be conserved while aerostat 50 is connected to ground unit 52. Based upon the foregoing, there is a need for a lighter tether that allows for an increase in any desirable load carried by aerostat 50. Moreover, there is need for a tether which provides more power to aerostat 50, provides redundancy and improved power delivery, and is configured to minimize an electromagnetic interference emanating therefrom.

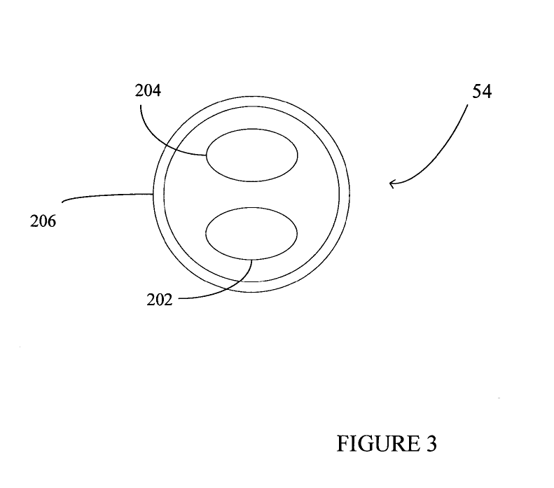

Now Referring to FIG. 3, one embodiment of tether 54 includes a power line 202 and a communications line 204. A protective outer layer 206 surrounds power line 202 and communication line 204. Protective outer layer 206 may be manufactured using an environmentally durable material, such as Kevlar® material that is manufactured by E.I. du Pont de Nemours and Company for example. In another embodiment, communication line 204 includes a fiber-optic line (optical fiber) as is known in the art. Power line 202 includes a conductive wire such as copper or other conductive material. Power line 202 and communication line 204 are configured to terminate in end 56 of tether 54. Moreover, attachment point 58 can include a solenoid driven release (not shown) that when actuated by aerostat controller 126 enable a detachment of the quick connect fitting ends from their corresponding receptacles.

Moreover, attachment points 58 and 60 may include attachment mechanisms that may be swiveling fixtures, such as ball joints. Alternatively, each of the attachment mechanisms may be a u-joint, gimbal, or other mechanism. Furthermore, aerostat 50 may utilize multiple attachment mechanisms for tether 54 having a plurality of coupling features. Further, each of the attachment mechanisms may include a decoupling mechanism, such as is a guillotine-type mechanism that severs tether 54 as needed. In addition to the solenoid-initiated quick release device, the decoupling mechanism may be realized as any of the following, without limitation: a pyrotechnic device, or a wide variety of other detachment mechanisms.

Referring back to FIGS. 2 and 3, ground unit 52 supply aerostat 50 with power via power line 202 so that power sources, such as power storage units, on board aerostat 50 may be conserved while aerostat 50 is connected to ground unit 52. Ground unit 52 may include a generator, a solar panel assembly, batteries, or other power sources from which to supply power to aerostat 50. Alternatively, tether 54 may be configured to incorporate a waveguide for Megawatt-level transmission of millimeter wave power.

As shown in FIG. 2, a ground unit controller 208 associated with ground unit 52 may use communication line 204 to transmit data to or receive data from aerostat controller 126, an autopilot unit (described below) of the aerostat 50, a controller of a payload 210 carried by aerostat 50, and/or additional component carried by aerostat 50. For example, ground unit controller 208 may transmit instructions to aerostat controller 126 regarding the altitude or attitude at which to maintain aerostat 50. In one embodiment, ground unit controller 208 may transmit instructions to the autopilot regarding a destination to which the aerostat 50 should fly if or when the aerostat 50 is disconnected from the ground unit 52. Ground unit controller 208 is configured to transmit instructions to the controller of payload 210 regarding data payload 210 may gather and/or actions payload 210 may undertake.

In one embodiment, ground unit controller 208 is configured to receive via communication line 204 data regarding the attitude and/or or altitude of aerostat 50 or of the operating status of the various components or systems of aerostat 50. Ground unit controller 208 may also receive via communication line 204 data collected by payload 210 or information regarding the operating status of the components associated with payload 210.

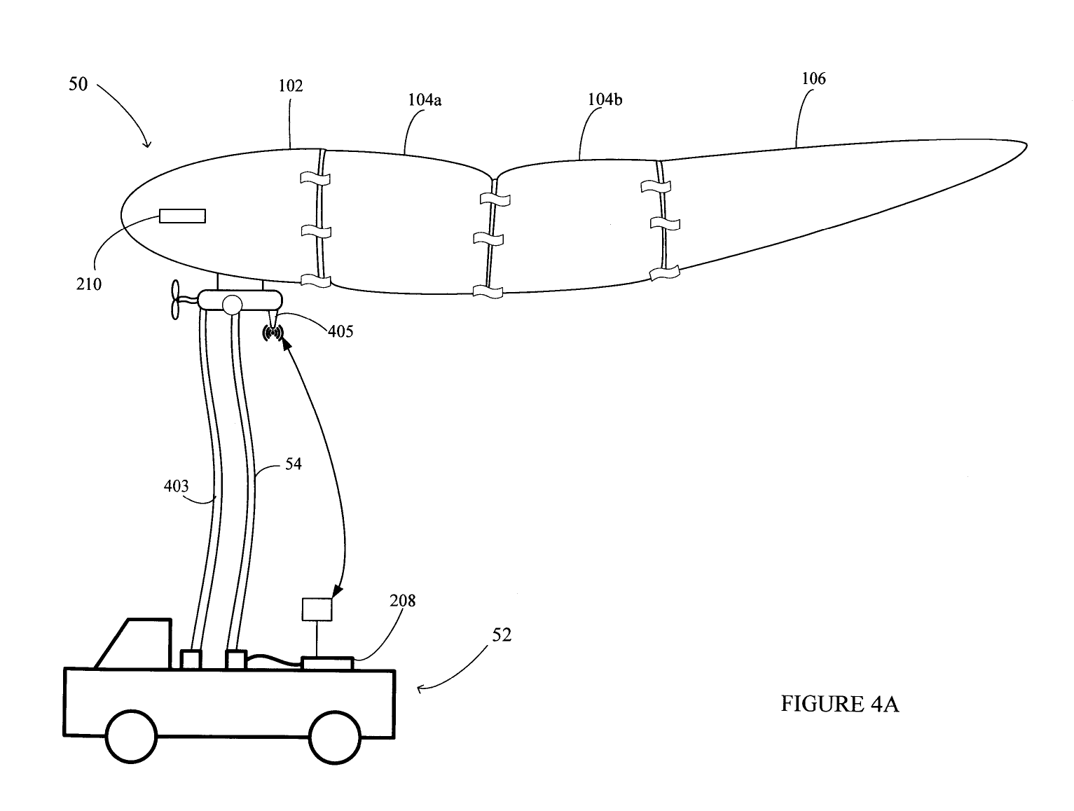

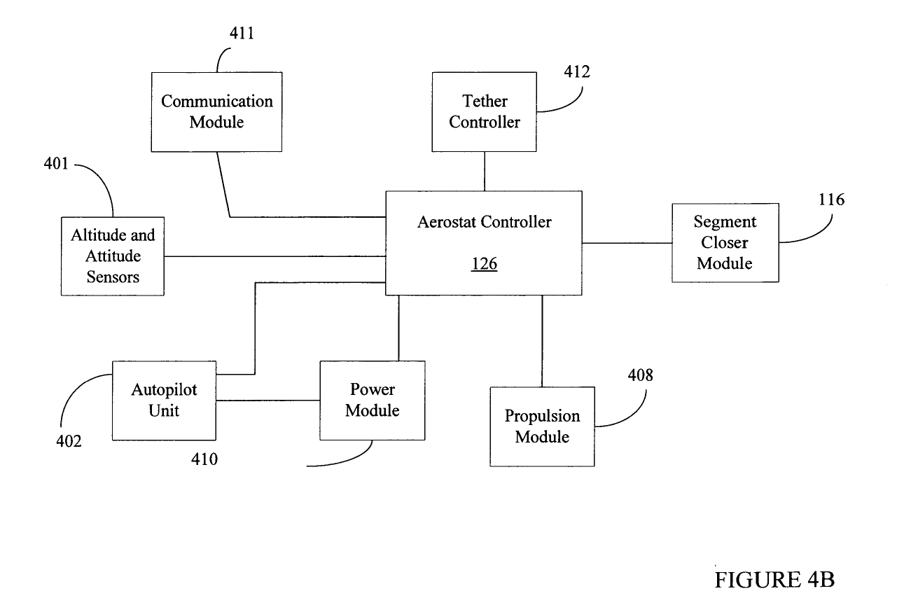

As shown in FIG. 4A, in one embodiment, ground unit controller 208 may communicate with the components on the aerostat 50 (including aerostat controller 126, payload 210, or the autopilot) using radio or other wireless communication means apparent to those of skill in the art. Moreover, ground unit controller 208 may communicate with the components on aerostat 50, using both wireless communication and the communication line 204. Alternatively, as shown in FIG. 4A, a power cable 403 that includes a power line (not shown) may not be integral to tether 54, and the wireless communication may be performed using an Omni directional antenna 405 connected to aerostat 50.

Referring back to FIG. 2, a remote controller 212, which may be located remotely from the ground unit 52, may also communicate with components on board aerostat 50. In one embodiment, remote controller 212 may utilize radio or other wireless communication means apparent to those of skill in the art to transmit data to ground controller unit 208. Ground controller unit 208 thereafter transmits such data to the components on the aerostat 50 as described above. Similarly, ground controller 208 may receive data from the aerostat 50 as described above and forward such data to remote controller 212. In another embodiment, remote controller 212 may communicate with the components of aerostat 50 directly.

In one embodiment, aerostat 50 can operate in an unmanned manner under control of controller 126. Moreover, ground unit 52 may also be unmanned after aerostat 50 has been launched. In another embodiment, the operation of aerostat 52 can be directed from remote controller 212.

In accordance with an exemplary embodiment, when aerostat 50 is secured to the ground by tether 54, the motors of propulsion module 130 are idle. In response to instruction signals from ground unit controller 208 or remote controller 212, aerostat controller 126 actuates such motors, confirms that propulsion module 130 is operational, disconnects tether 54, and navigates aerostat 50 to a predetermined location. In another embodiment, ground unit controller 208 or remote controller 212 may send instruction signals to direct aerostat controller 126 to activate the motors of propulsion module 130 and release aerostat 50 at a predetermined or particular time, or after a specified period of time elapses. Such instruction signals may direct aerostat controller 126 to release aerostat 50 when the weather is sufficiently favorable for flight. Further, remote controller 212 may be configured to remotely control the operation of aerostat 50, including propulsion maneuvers, flight maneuvers, and landing maneuvers.

To release tether 54, aerostat controller 126 directs a tether controller (described below) to actuate a release mechanism that disengages tether 54 from the first attachment point 58. Alternatively, to release tether 54, aerostat controller 126 directs the tether controller to actuate a release mechanism that disengages tether 54 from the second attachment point 60, and to trigger a retrieving mechanism that brings up tether 54 towards aerostat 50 for storage during the autonomous flight. This alternate arrangement of tether 54 facilitates the attachment of aerostat 50 to another ground unit that may not be equipped with a tether.

In one embodiment, before aerostat 50 is released from tether 54, ground unit controller 208 or remote controller 212 may send an instruction signal to the autopilot of aerostat 50 that includes a destination to which aerostat 50 should fly after its release. Ground unit controller 208 or remote controller 212 may send another instruction signal to aerostat controller 126 to undertake a controlled descent of aerostat 50. Such instruction signal may direct aerostat controller 126 to undertake the controlled descent of aerostat 50 immediately, at a particular time, or after a specified period of time elapses. Such instruction signals may direct aerostat controller 126 to controllably descend aerostat 50 when the weather is sufficiently favorable for such operation. In response to such instruction signals, aerostat controller 126 may direct segment controllers 124 of each segment 102, 104, and 106 to operate segment fill-fan-and-valve assembly 120 to deflate such segments. Aerostat controller 126 may also direct controllers 124 to operate segment closer modules 116 to control the stiffness of couplings 113 associated therewith to facilitate control of the descent of aerostat 50.

As such, one would recognize that the controlled descent of aerostat 50 may occur while aerostat 50 is attached to tether 54 or after aerostat 50 is released from tether 54. For example, ground unit controller 208 or remote controller 212 may direct aerostat controller 126 to actuate the motor of propulsion module 130, disengage aerostat 50 from tether 54 or disconnect tether 54 from ground unit 52, use propulsion module 130 to navigate to a predetermined location transmitted to the autopilot of aerostat 50, and controllably descend aerostat 50 or release tether 54 upon reaching such location.

In order to improve on the aerostat autonomous flying, aerostat controller 126 may be coupled to following sensors are used: a Global Positioning System (GPS) receiver (not shown), a digital compass (not shown) that provides the airship heading (yaw), pitch and roll angles, two piezoelectric vibrating gyros (not shown) that provide the pitch and yaw rates. Besides, an altimeter and a speedometer, both based on silicon piezo-resistive pressure sensors, may be used for helpful environment information.

In one exemplary embodiment, aerostat controller 126 is configured to detect whether the tether 54 is severed, unexpectedly disconnected, or otherwise compromised. In another embodiment, aerostat controller 126 is configured to monitor the power supplied through power line 202 and to determine that the tether 54 has been compromised if such power is interrupted. In still another embodiment, ground controller 208 or remote controller 212 may transmit a particular signal, such as a heartbeat signal, at predetermined intervals and aerostat controller 126 may determine that tether 54 has been compromised if such heartbeat signal is not received when expected. Other characteristics of tether 54 that may be monitored by aerostat controller 126 to determine continuity of tether 54 will be apparent/obvious to one of ordinary skills in the art.

Upon determining that tether 54 has been compromised, aerostat controller 126 may undertake instructions previously transmitted thereto and/or stored in a memory thereof. In one embodiment, such instructions may direct aerostat controller 126 to cause aerostat 50 to navigate to a predetermined location, and optionally, descend upon reaching such location. In another embodiment, such previously transmitted and/or stored instructions may direct aerostat controller 126 to immediately begin a controlled descent of aerostat 50 once tether 54 is compromised.

Moreover, if tether 54 is compromised, the previously transmitted or stored instructions may cause aerostat controller 126 to direct segment controllers 124 to dump the lifting gas from one or more of the segments 102, 104, and 106 of aerostat 50 to facilitate a rapid descent of aerostat 50. Other actions that may be undertaken in response to a determination that tether 54 has been compromised will be apparent/obvious to one of ordinary skills in the art.

The actions described above that may be undertaken when aerostat controller 126 determines that tether 54 has been compromised may also be undertaken in other emergency situations. Further, such actions may be undertaken upon a command transmitted by ground control unit 208 and/or remote controller 212.

Referring to FIG. 4B, a control system 400 of the aerostat 50 includes aerostat controller 126 described above coupled to altitude and attitude/condition sensors 401. Altitude and attitude sensors 401 may include a pitot tube 401a and a GPS module 401b. Aerostat controller 126 is also coupled to each segment controller 416 associated with a segment 102, 104, or 106, a coupling controller 418 associated with each coupling 13, an autopilot unit 402, and a propulsion module 408. In one embodiment, aerostat controller 126 is configured to monitor the readings from the altitude and attitude sensors 401 to manage the in-flight vector parameters, air speed, and to control the altitude and attitude of aerostat 50. Moreover, aerostat controller 126 is configured to communicate with autopilot unit 402, ground unit controller 208, and/or the remote controller 212 in order to keep aerostat 50 in a substantially stationary position or to correctly travel to a predetermined location at a predetermined altitude.

Aerostat controller 126 is configured to control a propulsion module 408 to move the head segment 102 in a particular direction and control the attitude of head segment 102. Aerostat controller 126 also monitors and adjusts the inflation pressure, the heading, and the attitude of each of the segments 102, 104, and 106 to ensure that remaining segments 104 and 106 of aerostat 50 follow head segment 102 while minimizing the forces of the wind on the segments of aerostat 50. As such, on board propulsion module 408 and controller 126 enable aerostat 50 to handle changes in ambient wind, and hence can relocate and fly around.

Control system 400 further includes a power module 410 to provide electrical power to the components thereof. Power module 410 may provide power supplied via power line 202 in tether 54, if available, or from a power source onboard aerostat 50. The onboard power source may be any suitable source of electrical energy including a battery, solar cell, wind generator, or a combination thereof. Alternatively, the onboard power source may be a self-harvesting power unit that draws its electrical energy from mechanical energy generated by aerostat movements, such as on vibrations and oscillations.

Control system 400 further includes a communication module 411 coupled to the airship controller 126 that includes a transceiver to facilitate wired or wireless communications between aerostat controller 126 and ground unit controller 208 and/or the remote controller 212.

In one embodiment, aerostat controller 126 is coupled to a tether controller 412, which is configured to monitor the continuity of tether 54 and to provide signals to aerostat controller 126 that indicate whether tether 54 has been compromised. Further, tether controller 412 is configured to control the solenoid driven release to disengage aerostat 50 from tether 54.

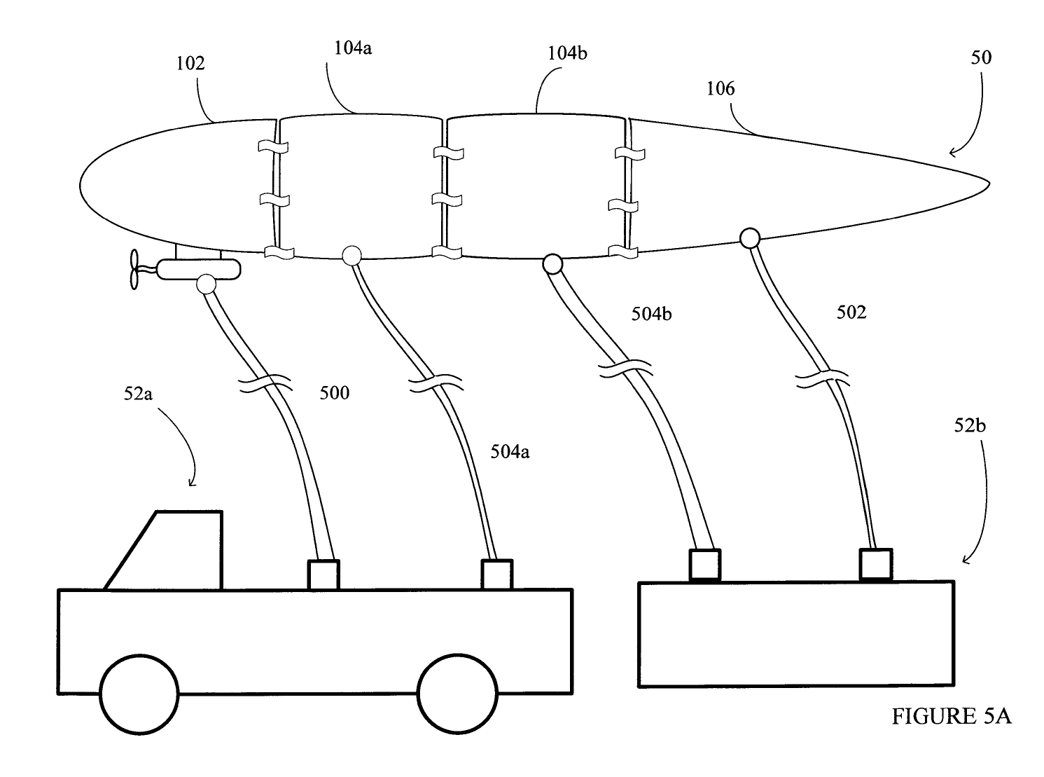

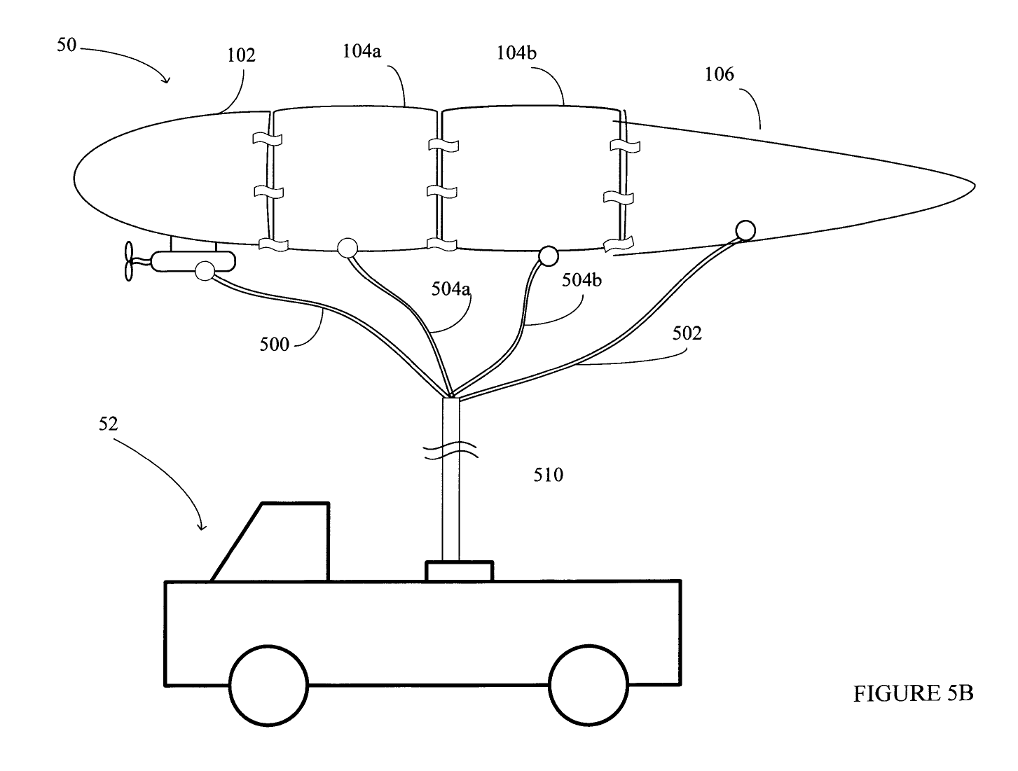

In the above described embodiments, tether 54 is the only element attaching/securing aerostat 50 to ground unit 52. In another embodiment, multiple tethers may be used. Now referring to FIG. 5A, for example, a first tether 500 may secure head segment 102 to ground unit 52a, and a second tether 502 may secure tail segment 106 to ground unit 52b. Further, additional tethers may be used to secure middle body segments 104a and 104b to ground units 52a and 52b. As such, tethers 500, 502, and 504a and 504b do not have to be simultaneously attached to the same ground unit. As shown in FIG. 5A, tethers 500 and 504a are attached to ground unit 52a and tethers 502 and 504b are attached to ground unit 52b. Tethers 500, 502, 504a, and 504b may be each connected to aerostat 50 using quick connect fittings that may be released electronically by aerostat controller 126 as described above. Further, the power and/or communication lines may be incorporated in all or some such tethers 500, 502, 504a, and 504b. Some of tethers 500, 502, 504a, and 504b may not include any power and/or communication lines but may be used only for securing or stabilizing aerostat 50.

Referring to FIG. 5B, one or more of the tethers 500, 502, 504a, and/or 504b, may be collected into a single tether 510 that is secured to ground unit 52. Collecting tethers 500, 502, 504a, and 504b in this manner may ease their management when used to secure or stabilize aerostat 50.

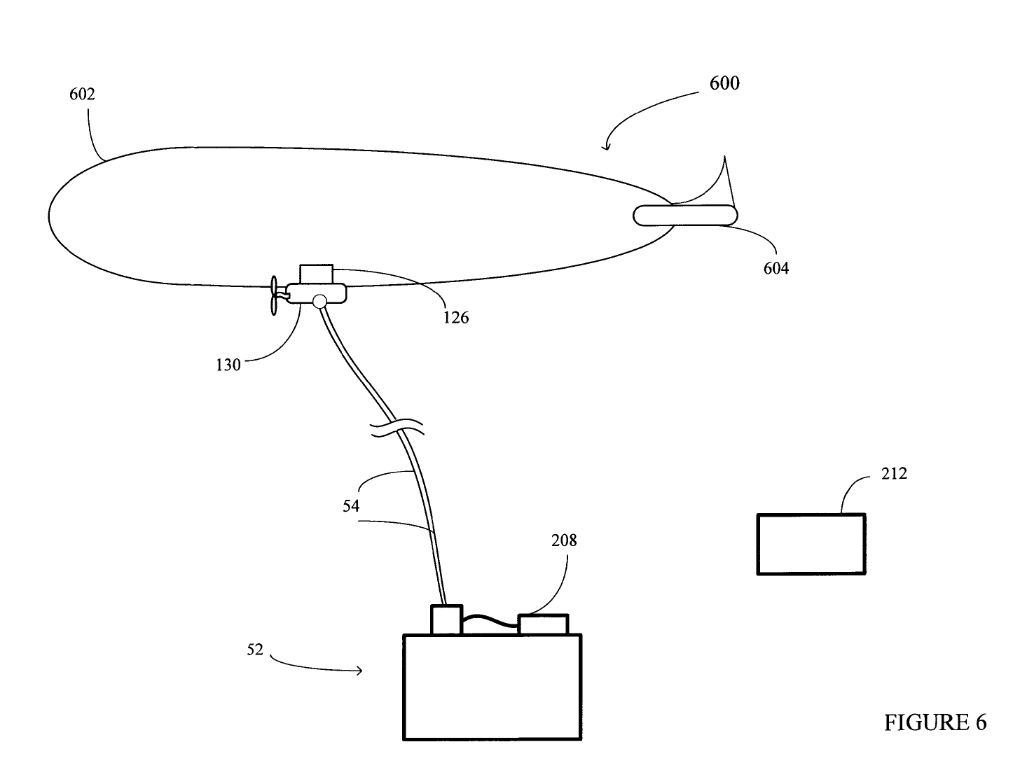

Referring to FIG. 6, one exemplary embodiment of an aerostat 600 that includes a non-segmented rigid outer envelope 602 is shown. Aerostat 600 further includes controller 126, and propulsion module 130. In another embodiment, instead of being rigid, outer envelope 602 includes an inflatable shell. One or more ballonets may be disposed within outer envelope 602 to control lift and stability of aerostat 600. Similarly to aerostat 50, one end 56 of tether 54 is releasably coupled to attachment point 58 on aerostat 600. Another end 60 of tether 54 is coupled to attachment point 62 of ground unit 52. Ground unit controller 208 and/or remote controller 212 receive information from and transmit instruction signals to controller 126 of aerostat 600 as described above.

As discussed above, if controller 126 receives an instruction from ground unit controller 208 or remote controller 212 to disengage tether 54 from aerostat 600 or from ground unit 52, controller 126 is configured to trigger an activation of propulsion unit 130, confirms that propulsion unit 130 is operational, and disengages tether 54 from the aerostat 600 or from ground unit 52. Thereafter, controller 126 navigates aerostat 600 in accordance with instruction signals received from ground unit controller 208 and/or remote controller 212. In one embodiment, aerostat 600 includes tail fins 604 to facilitate control and stability during flight thereof. In another embodiment, controller 126 is configured to operate fins 604.

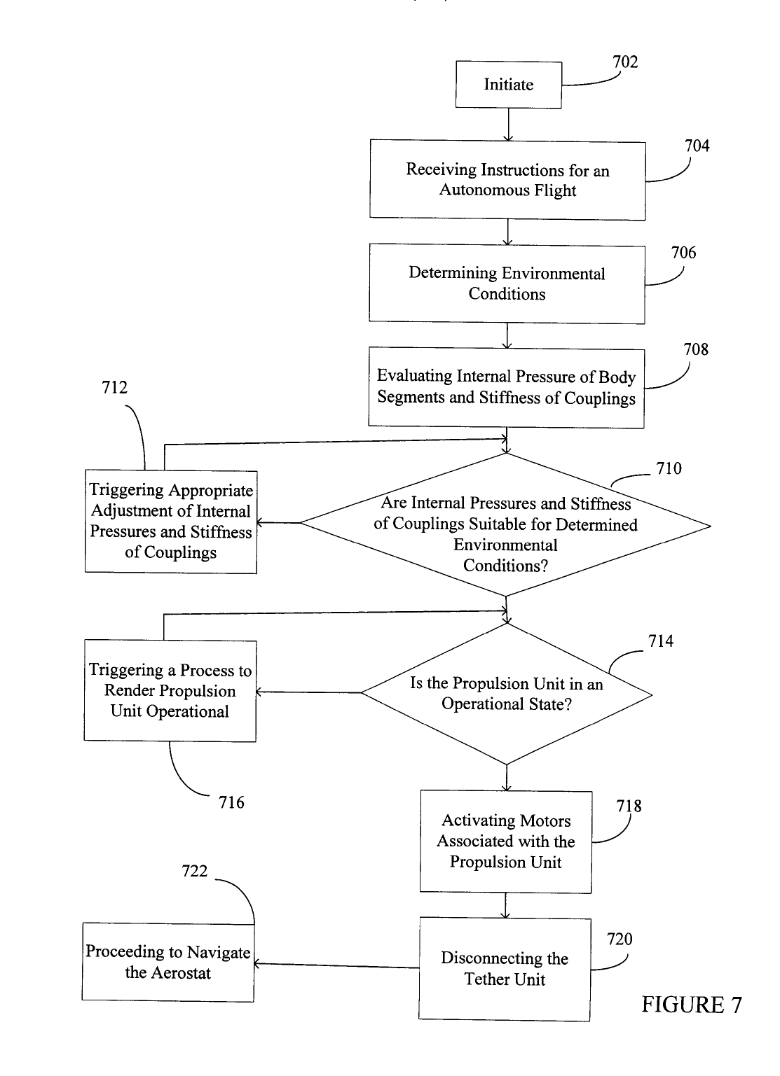

Now referring to FIG. 7, a flow chart shows an exemplary method 700, initiated at Step 702, for releasing and controlling aerostat 50. At Step 704, controller 126 receives instructions signals for an autonomous flight of aerostat 50 to a predetermined location. At Step 706, controller 126 is configured to determine environmental conditions affecting aerostat 50. Following the determination of the environmental conditions, controller 126 evaluates an internal pressure of each of the body segments of aerostat 50 and a stiffness of each of the couplings connecting adjacent segments, at Step 708. Subsequently, controller 126 is configured to determine whether these internal pressure and stiffness evaluations are suitable for the determined environmental conditions, at Step 710. In case, the evaluations are found to be non-suitable, controller 126 is configured to trigger an appropriate adjustment of the internal pressures of the segments and stiffness of the couplings, at Step 712. Otherwise, controller 126 is configured to proceed with a determination of whether the propulsion unit is in an operational state, at Step 714. In the negative, controller 126 triggers a process that renders the propulsion unit operational, at Step 716. Otherwise, controller 126 proceeds to activate motors associated with the propulsion unit, at Step 718. Subsequently, controller 126 triggers a disconnection of tether 54, at Step 720, and proceeds to navigate aerostat 50 to a predetermined destination based on the received instructions signals, at Step 722.

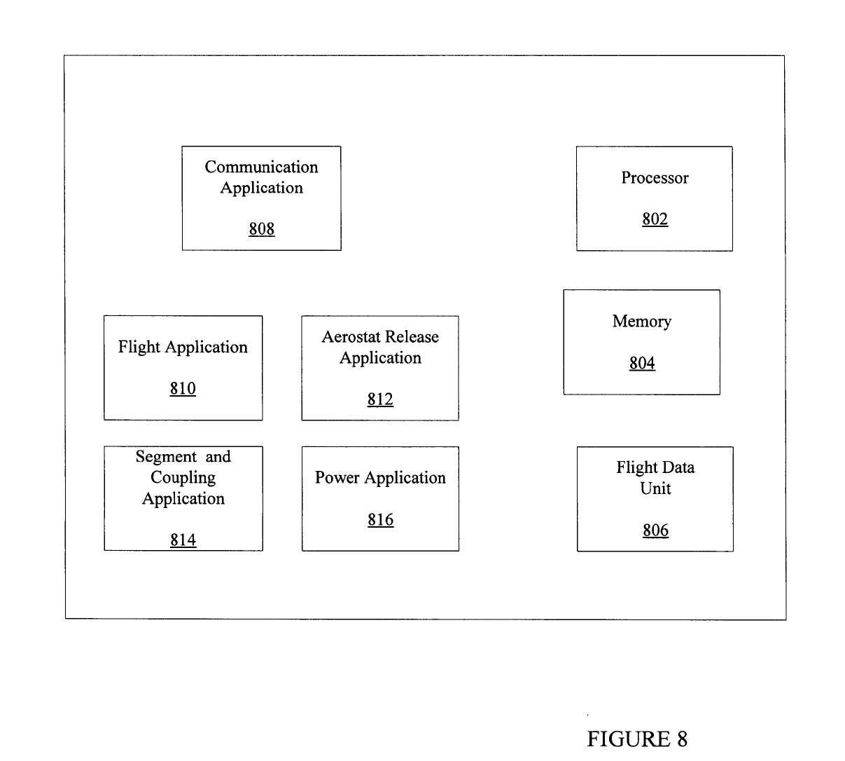

Now referring to FIG. 8, in which a block diagram 800 illustrates components of controller 126. As shown, controller 126 includes a processing unit 802, a memory unit 804, a flight data unit 806, a communication application 808, a flight control application 810, an aerostat release application 812, a segment and coupling control application 814, and a power control application 816. Communication application 808 is configured to receive data from communication module 411 and to provide instructions based on the received data. Flight control application 810 is configured to analyze data received from tether controller 412, altitude and attitude sensors 400, autopilot unit 402, and propulsion module 408, and generate instructions based on the received data. Aerostat release application 812 is configured to request and analyze data indicative of the status of tether 54 and of operational status of propulsion module when autonomous flight instructions are received from remote controller 212. Power control application 416 is configured to monitor the state of charge (SOC) of power sources integral to aerostat 50 and power transmission provided through power line 202.

Processing unit 802 can be implemented on a single-chip, multiple chips or multiple electrical components. For example, various architectures can be used including dedicated or embedded processor or microprocessor (μP), single purpose processor, controller or a microcontroller (μC), digital signal processor (DSP), or any combination thereof. In most cases, processing unit 802 together with an operating system operates to execute computer code and produce and use data. Memory unit 804 may be of any type of memory now known or later developed including but not limited to volatile memory (such as RAM), non-volatile memory (such as ROM, flash memory, etc.) or any combination thereof, which may store software that can be accessed and executed by processing unit 802, for example.

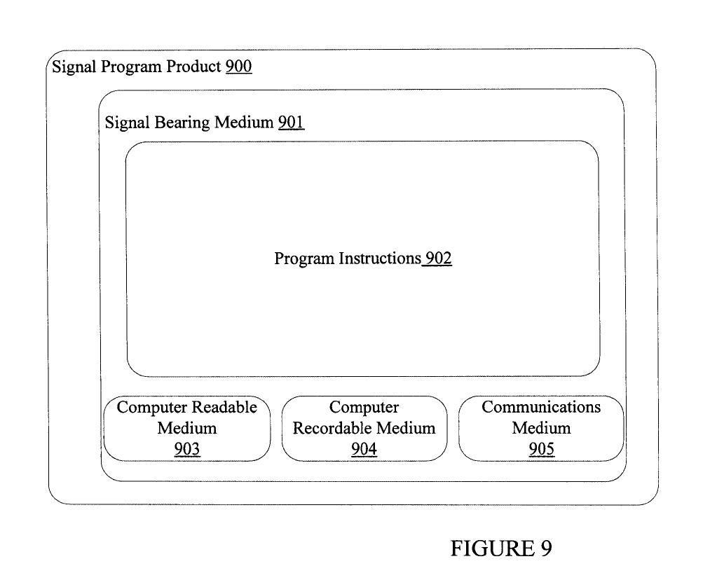

In some embodiments, the disclosed method may be implemented as computer program instructions encoded on a computer-readable storage media in a machine-readable format. FIG. 9 is a schematic illustrating a conceptual partial view of an example computer program product 900 that includes a computer program for executing a computer process on a computing device, arranged according to at least some embodiments presented herein. In one embodiment, the example computer program product 900 is provided using a signal bearing medium 901. The signal bearing medium 901 may include one or more programming instructions 902 that, when executed by a processing unit may provide functionality or portions of the functionality described above with respect to FIG. 7. Thus, for example, referring to the embodiment shown in FIG. 7, one or more features of blocks 702-720, may be undertaken by one or more instructions associated with the signal bearing medium 901.

In some examples, signal bearing medium 901 may encompass a non-transitory computer-readable medium 903, such as, but not limited to, a hard disk drive, memory, etc. In some implementations, signal bearing medium 901 may encompass a computer recordable medium 904, such as, but not limited to, memory, read/write (R/W) CDs, R/W DVDs, etc. In some implementations, signal bearing medium 901 may encompass a communications medium 905, such as, but not limited to, a digital and/or an analog communication medium (e.g., a fiber optic cable, a waveguide, a wired communications link, etc.).

It will be appreciated that some embodiments may be comprised of one or more generic or specialized processors such as microprocessors, digital signal processors, customized processors and field programmable gate arrays (“FPGAs”) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

In one embodiment, the method 700 may also be implemented in hardware using any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In the foregoing specification, specific embodiments have been described. However, various modifications and changes can be made without departing from the scope of the claims herein. For example, method steps are not necessarily performed in the order described or depicted, unless such order is specifically indicated. Accordingly, the specification and figures are to be regarded in an illustrative rather than a restrictive sense, and all such modifications are intended to be included within the scope of the claims.

1. A computer-implemented method for releasing and controlling an airship, the method comprising:
receiving instruction signals to release the airship for an autonomous flight, wherein the airship includes a plurality of body segments and a plurality of coupling elements for coupling adjacent body segments along a length of the airship, wherein the airship is detachably coupled to a ground unit through a tether unit, and wherein the airship includes a propulsion unit, an auto pilot unit, and a controlling unit for controlling the propulsion unit, the tether unit, and the auto pilot unit;
determining environmental conditions affecting the airship;
evaluating an internal pressure level of each of the plurality of body segments and a stiffness level of each of the couplings elements;
determining whether the evaluated internal pressure levels and stiffness levels are substantially suitable to the determined environmental conditions;
based on a determination that the evaluated internal pressure levels and stiffness levels are substantially suitable to the determined environmental conditions, determining whether the propulsion unit is in an operational state;
based on the determination that the propulsion unit is in an operational state, triggering a disconnection of the tether unit and an activation of the auto pilot unit.

2. The computer-implemented method of claim 1, further comprising:
receiving instruction signals from a remote controller to control propulsion maneuvers, flight maneuvers, and landing maneuvers.

3. The computer-implemented method of claim 1, further comprising:
determining that a power source integral to the airship has a suitable state of charge prior to activating motors of the propulsion unit.

4. The computer-implemented method of claim 1, wherein the disconnection of the tether unit includes disconnecting the tether unit from the airship.

5. The computer-implemented method of claim 1, wherein the disconnection of the tether unit comprises disconnecting the tether unit from the ground unit and retrieving the tether unit to the airship.

6. The computer-implemented method of claim 1, further comprising:
adjusting the internal pressure levels of the body segments and the stiffness levels of the couplings as appropriate based on detected changes of environmental conditions during the autonomous flight of the airship.

7. The computer-implemented method of claim 6, wherein the adjustment of the internal pressure levels of the body segments and the stiffness levels of the couplings serve to minimize environmental forces affecting the body segments of the airship.

8. An airship comprising;
a plurality of body segments Tillable with lighter than air gases;
a plurality of coupling elements, each of which is positioned to couple adjacent body segments along a length of the airship;
a propulsion unit for facilitating an autonomous flight of the airship;
a controlling unit for triggering a release of a tether unit detachably securing the airship to a ground unit while the airship is aloft, for actuating the propulsion unit, and for controlling internal pressure levels of the body segments and stiffness levels of the coupling elements.

9. The airship of claim 8, wherein the plurality of body segments include a head body segment, a tail body segment, and middle body segments.

10. The airship of claim 8, wherein internal pressure levels of the body segments and stiffness levels of the coupling elements are adjust tom minimize environmental forces affecting the airship while aloft or during the autonomous flight.

11. The airship of claim 8, wherein the tether unit comprises a plurality of tethers, each of which can be releasably connected to one of the plurality of body segments.

12. The airship of claim 8, wherein the controlling unit triggers the release of the tether unit by disconnecting the tether unit from the airship.

13. The airship of claim 8, wherein the controlling unit triggers the release of the tether unit by disconnecting the tether unit from the ground unit and retrieving the tether unit towards the airship.

14. The airship of claim 8, wherein each of the plurality of body segments includes a segment controlling unit, a sensor unit, a segment fill-fan-and-valve assembly, and a pressure sensor unit.

15. The airship of claim 14, wherein the segment controlling unit is configured to receive measurement signals from the sensor unit and from the pressure sensor unit, and to serialize and transmit the measurements signals to the controlling unit.

16. The airship of claim 14, wherein the sensor unit includes one or more instrument sensors such as a magnetic compass, an inertial navigation sensor, and a three-axis position sensor.

17. A non-transitory computer-readable medium comprising instructions executing a method for releasing and controlling an airship, the method comprising:
receiving instruction signals to release the airship for an autonomous flight, wherein the airship includes a plurality of body segments and a plurality of coupling elements for coupling adjacent body segments along a length of the airship, wherein the airship is detachably coupled to a ground unit through a tether unit, and wherein the airship includes a propulsion unit, an auto pilot unit, and a controlling unit for controlling the propulsion unit, the tether unit, and the auto pilot unit;
determining environmental conditions affecting the airship;
evaluating an internal pressure level of each of the plurality of body segments and a stiffness level of each of the couplings elements;
determining whether the evaluated internal pressure levels and stiffness levels are substantially suitable to the determined environmental conditions;
based on a determination that the evaluated internal pressure levels and stiffness levels are substantially suitable to the determined environmental conditions, determining whether the propulsion unit is in an operational state;
based on the determination that the propulsion unit is in an operational state, triggering a disconnection of the tether unit and an activation of the auto pilot unit.

18. The non-transitory computer-readable medium of claim 17, further comprising:
receiving instruction signals from a remote controller to control propulsion maneuvers, flight maneuvers, and landing maneuvers.

19. The non-transitory computer-readable medium of claim 17, further comprising:
determining that a power source integral to the airship has a suitable state of charge prior to activating motors of the propulsion unit.

20. The non-transitory computer-readable medium of claim 17, wherein the disconnection of the tether unit includes disconnecting the tether unit from the airship.

21. The non-transitory computer-readable medium of claim 17, wherein the disconnection of the tether unit comprises disconnecting the tether unit from the ground unit and retrieving the tether unit to the airship.

22. The non-transitory computer-readable medium of claim 17, further comprising:
adjusting the internal pressure levels of the body segments and the stiffness levels of the couplings as appropriate based on detected changes of environmental conditions during the autonomous flight of the airship.

23. An airship system comprising:
an airship comprising:
a plurality of body segments Tillable with lighter than air gases;
a plurality of coupling elements, each of which is positioned to couple adjacent body segments along a length of the airship;
a propulsion unit for facilitating an autonomous flight of the airship;
a controlling unit for actuating the propulsion unit, and for controlling internal pressure levels of the body segments and stiffness levels of the coupling elements;
a tether unit detachably securing the airship to a ground unit while the airship is aloft;
a remote control unit for providing wirelessly instruction signals to the airship.

24. The airship system of claim 23, wherein the tether unit comprises a power line and a communication line.

25. The airship system of claim 23, wherein the tether unit includes a plurality of tethers, each of which is detachably connected to one of the body segments.
